(19) United States
(12) Patent Application Publication
(10) Pub. No.: US 2013/0097197 A1
(43) Pub. Date: Apr. 18, 2013

(54) METHOD AND APPARATUS FOR PRESENTING SEARCH RESULTS IN AN ACTIVE USER INTERFACE ELEMENT

(71) Applicants: Aaron RINCOVER, Berlin (DE); Tomasz DOBROWOLSKI, Berlin (DE); Andrea GIAMMARCHI, Berlin (DE)

(72) Inventors: Aaron RINCOVER, Berlin (DE); Tomasz DOBROWOLSKI, Berlin (DE); Andrea GIAMMARCHI, Berlin (DE)

(73) Assignee: NOKIA CORPORATION, Espoo (FI)

(21) Appl. No.: 13/274,126

(22) Filed: Oct. 14, 2011

(51) Int. Cl. G06F 17/30

(52) U.S. Cl. 707/766; 707/772; 707/E17.014

(57) ABSTRACT

An approach is provided for presenting search results in an active user interface element at specific location in a user interface that correspond to the desired information with respect to user interface search element. An element of a user interface receiving a search parameter enables processing of the search parameter to yield location information of the desired information. The location or locations of the desired information are then presented to a user on the user interface.

### BACKGROUND

Service providers (e.g., wireless, cellular, etc.) and device manufacturers are continually challenged to deliver value and convenience to consumers by, for example, providing compelling network services. One area of interest has been the development of services for providing location-based information over, for instance, the Internet, in response to queries or searches for people, places or things. This desire to search for online location information has resulted in an abundance of available potentially relevant location-based information. Accordingly, service providers and device manufacturers face significant technical challenges to enable users to discover, access, and view such location information in an efficient and effective manner.

### SOME EXAMPLE EMBODIMENTS

Therefore, there is a need for an approach for presenting search results in an active user interface element.

According to one embodiment, a method comprises determining an input specifying at least one point in a user interface. The method also comprises causing, at least in part, a rendering of a search user interface element at the at least one point. The method further comprises determining to generate a search query that includes, at least in part, the at least one point as a search parameter.

According to another embodiment, an apparatus comprising at least one processor, and at least one memory including computer program code, the at least one memory and the computer program code configured to, with the at least one processor, cause, at least in part, the apparatus to determine an input specifying at least one point in a user interface. The apparatus is further caused to cause, at least in part, a rendering of a search user interface element at the at least one point. Furthermore, the apparatus is caused to determine to generate a search query that includes, at least in part, the at least one point as a search parameter.

According to another embodiment, a computer-readable storage medium carrying one or more sequences of one or more instructions which, when executed by one or more processors, cause, at least in part, an apparatus to determine an input specifying at least one point in a user interface. The apparatus is further caused to cause, at least in part, a rendering of a search user interface element at the at least one point. Furthermore, the apparatus is caused to determine to generate a search query that includes, at least in part, the at least one point as a search parameter.

According to another embodiment, an apparatus comprises means for determining an input specifying at least one point in a user interface. The apparatus also comprises means for causing, at least in part, a rendering of a search user interface element at the at least one point. The apparatus further comprises means for determining to generate a search query that includes, at least in part, the at least one point as a search parameter.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (including derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of presenting search results in an active user interface element, according to one embodiment;

FIG. 2 is a diagram of the components of user equipment capable of presenting an active user interface element, according to one embodiment;

FIG. 3 is a flowchart of a process for determining a search query and rendering one or more search results, according to one embodiment;

FIG. 4 is a flowchart of a process for determining another search query and rendering one or more other search results, according to one embodiment;

FIGS. 5-8 are diagrams that illustrate example user interfaces used in the processes of FIGS. 3 and 4, according to various embodiments;

FIG. 9 is a diagram of hardware that can be used to implement an embodiment of the invention;

FIG. 10 is a diagram of a chip set that can be used to implement an embodiment of the invention; and

FIG. 11 is a diagram of a mobile terminal (e.g., handset) that can be used to implement an embodiment of the invention.

### DESCRIPTION OF SOME EMBODIMENTS

Examples of a method, apparatus, and computer program for presenting search results in an active user interface element are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

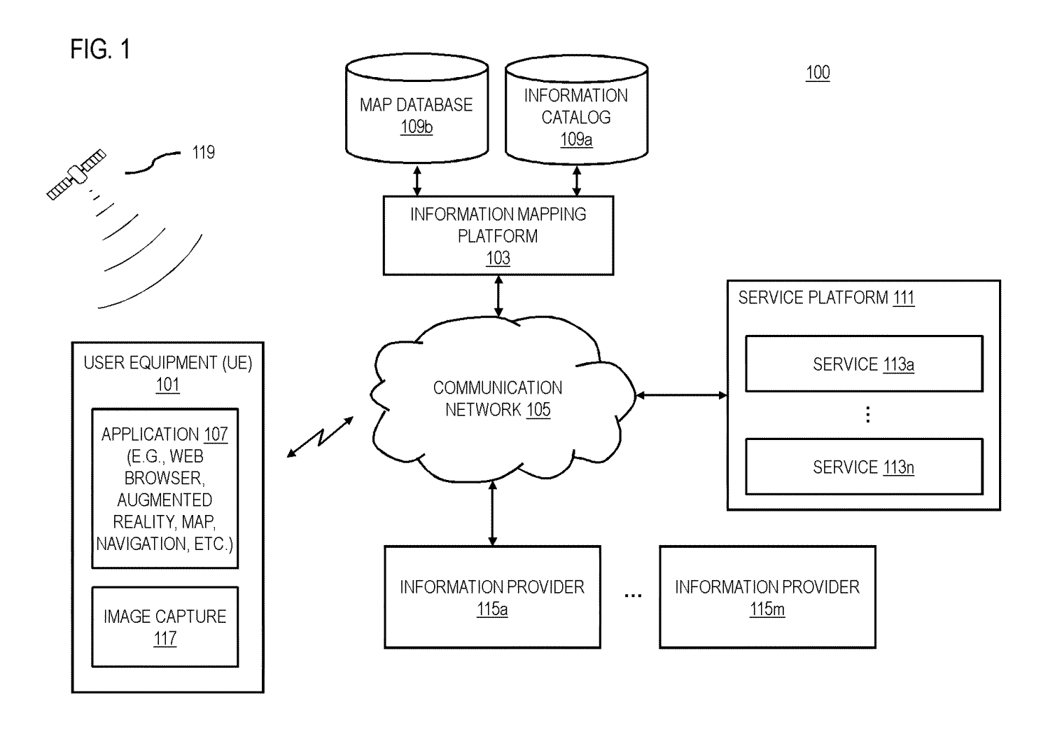

FIG. 1 is a diagram of a system capable of presenting search results in an active user interface element, according to one embodiment. It is noted that mobile and computing devices in general are becoming ubiquitous in the world today and with these devices, many services are being provided. These services can include, search engines, location-based services, augmented reality (AR) and mixed reality (MR), services and applications. Search results and/or content items at a user device in conjunction with AR allow a user's view (e.g., 2D and 3D) of the real world to be overlaid with additional visual information associated with the search results and/or the content items. Similarly, MR enables a unique presentation of search results and related information by allowing for the merging of real and virtual worlds to produce visualizations and new environments. In MR, physical and digital objects can co-exist and interact in real time. Thus, MR can be a mix of reality, AR, virtual reality, or a combination thereof.

Generally, a user may utilize a user device (e.g., computers, mobile devices, PDAs, etc.) to search for and/or request information and/or content items available over the Internet. However, a vast collection of available information can quickly overwhelm the user, thereby making it extremely difficult for the user to identify and access information of interest. In one embodiment, such information may be associated with location information including, for instance, geographical or physical location of the user and/or a location of specified points of interest (POIs) by the user. Further, the information may be associated with one or more categories specified by a service provider and/or a database provider. For example, a user wishes to search for restaurants based on a particular location (e.g., a user location, at a given city, etc.), a category (e.g., Italian food) and/or other parameters, creates and submits a search query to a service provider (e.g., a search engine) via a user interface (UI) (e.g., typing into a text box on a header of a web page, a search box on a side panel of the UI, a map application, via audio interface, etc.) on the user device. Further, available search results from the service provider may be presented to the user via the UI on a map application and/or may be listed with text, flags, points, pins, etc. on the map.

However, with this method there often is a disconnection between where the user may enter/type the search parameters and how the search results are displayed. For example, the search results may be presented in a list and on a map, but the user may not be able to readily ascertain as how the search results in the list correlate to locations (e.g., pins) shown on a map (e.g., no text next to each pin.) It would require additional effort by the user to associate the results in the list with the pins shown on the map. For example, a user would have to go to the items shown in the list, hover and/or click on each item and look for the pin on the map. Alternatively, the user can go to each pin on the map, hover and/or click on it to display its information. Another challenge for users is that a new search enquiry typically erases previous search parameters and/or results or completely replaces them with new results. For example, a user may wish to search for one or more information items and create an itinerary, (e.g., “an evening out on the town”) based on the one or more information items wherein the challenge would be to concurrently view multiple selected items on a map application. An example challenge for a user would be to submit a search enquiry for a first POI (e.g., a restaurant) at the city center and then another enquiry for a second POI (e.g., a bar) near that restaurant wherein the user wishes a displaying of a list, a mapping route and other information related only to the first and second POIs. As such, technical challenges arise in effectively associating and presenting one or more search results in one or more applications for efficient user consumption.

One conventional approach to search for information related to POIs is to submit a query via a UI search element. However, if the UI search element is displayed at a different location in the UI than the possible search results, then there is a discontinuity between viewing the search results, for example on a map application, and the UI search element. Further, if a user wishes to conduct another search, the previous search results are replaced with the new search results. Another conventional approach is to present search results as a list. However, in either case, these traditional approaches may not be effective in situations where the density of search results correlating to the desired information item or search result is high as well as the fact that viewing of the search results and utilizing the UI search element are not harmonious. More specifically, the high density of information can make arrows, pointers, and/or lists long and uninteresting to a user. Moreover, the user may not find a desired result if the result is buried among many other items. Without an exciting or novel presentation, information that would otherwise appeal to a user might go unnoticed and be missed.

To address the problems described above, a system 100 of FIG. 1 introduces the capability of presenting an active and/or transforming, user interface (UI) element that enables a user to: (1) input search parameters or terms for one or more queries, (2) receive and view the search result in one or more applications in the context of the UI presenting the results. For example, in an augmented reality UI, the system 100 can present a search element at a point within the augmented reality display that is most relevant to the search (e.g., at a point corresponding to a location from which to initiate a location based query). In some embodiments, multiple search elements and corresponding results may be linked to form more complex queries (e.g., when querying from one location to other waypoints, destinations, etc. to create an itinerary). For example, a user of the system 100 may use a search element (e.g., as described in various embodiments discussed herein) to select a resulting first location (e.g., a restaurant search) and then initiate another search from another search element presented in the UI at a point corresponding to the selected restaurant. The user may, for instance, search for bars nearby the selected restaurant. The system 100 can then link and present these selected restaurant and the selected bar to present an itinerary to the user.

In some embodiments, search terms available for input into the active search UI element may be presented as categories (e.g., POI categories such as restaurants, theaters, etc.). Accordingly, the user need not, for instance, enter manual search terms (e.g., type in “Restaurant”, “Bar”, etc.). Instead, the user may click on a category in the active search UI element, select results associated with the category, and continue with other results as needed. In some embodiments, the system 100 may present, for instance, the most popular categories, most frequently categories, recommended categories, etc. to reduce the number of categories initially presented to the user for selection.

Although various embodiments are described with respect to mapping, augmented reality, 2D, 3D, virtual reality display, and the like, it is contemplated that the various embodiments of the approach described herein are also applicable to any other content, application, service, etc. that present the search results associated with one or more POIs. For example, a user may submit one or more search queries for one or more information items related to one or more POIs wherein the search parameters may be submitted via a UI element while viewing the search results in another UI element. In either case, the system 100 can use, for instance, the position of the active search UI element to determine at least one search parameter (e.g., a starting location of a search). The system 100 can then combine any search terms input via the search element with the determine search parameter to initiate a query. In this way, the user can more easily recognize, for instance, the originating point of a search (e.g., a location based search) because the active search UI is presented within the environmental context (e.g., augmented reality, virtual reality, etc.) through which the results (e.g., points-of-interests or other location-based results) are to be displayed.

In one embodiment, the active search UI element can be initially presented at any position within the UI. In another embodiment, the user may decide where to initially put the element to indicate where to start a search. By way of example, the active search UI element includes, at least in part, a search parameter input area and related visualization (e.g., a search magnifying glass icon) to indicate that the UI element is search box or a tool. A user can then, for instance, enter search parameters in the input area and then select the icon to initiate the search. Further, it is contemplated that an active search UI elements is applicable to querying for any number of items including, at least in part: any item with a location in the real world or map, e.g., a building, city, country, event, person, terrain feature, geo-tagged information, time, day and/or other points of interest (POIs).

In one embodiment, on initiation of the search, one or more applications on the user device (e.g., a map application, a calendar application, a contacts list, an AR application, an MR applications, etc.) and/or at a service provider can be executed in order to utilize one or more search results available from the search query.

In another embodiment, the UI may support multiple active search elements at the same time. In addition, a single active search UI element may transform into multiple search result elements if there are more than one result of the search present in the UI. In addition or alternatively, the single active search UI element can move from one search result location to another location in a sequential manner. By way of example, the sequential indication may be based on relevance of the search result (e.g., the active search UI element travels to the most relevant result first, then the next most relevant, and so on), proximity to the active search UI element, or any other criteria.

In one embodiment, a user submits an input specifying at least one point in a user interface (UI) wherein the UI includes, at least in part, a selection of one or more category-based search terms. For example, a user submits one or more terms in a first UI element via text, audio, upload, gesture and the like user actions wherein the first UI element may be a text box, an upload interface link, an audio capture box and the like. In another embodiment, one or more search UI elements are rendered at the at least one point. For example, a UI element is presented to the user for entering text wherein the UI element is substantially at the same location as the first UI element. In another embodiment, a search query including, at least in part, the at least one point as a search parameter is generated. For example, the search terms of the first UI element are utilized to generate a search query wherein the search query includes, at least in part, a location-based query, an information query, a web query, or a combination thereof; and wherein the user interface is for, at least in part, a mapping application, a navigation application, an augmented reality application, a virtual reality application, or a combination thereof.

In another embodiment, one or more results of the search query in the user interface are rendered based, at least in part, on location information associated with the one or more results. For example, location information associated with the one or more search results are utilized to present them on a map application. By way of example, the system 100 may use any number of stylized rendering effects to differentiate or highlight different search results. In one embodiment, the system 100 can vary the display height (e.g., a z-axis) height of the presented result to highlight different results. In one example, the system 100 can vary the height of location-based results based on the granularity of associated location information (e.g., if location granularity is a city level, the city can be display higher or prominently, with results associated with increasing granularity presented lower with respect to the z-axis). In a 2D context, different rendering characteristics (e.g., font sizes, colors, graphics, icons, etc.) can be used to differentiate search results. It is also contemplated that any other rendering techniques can be used in either the 2D or 3D context to enable differentiation of search results.

In one embodiment, another input for selecting at least one of the one or more results is determined; for example, a user clicks/selects one of the results presented in a list and/or on a map application. In one embodiment, another search UI element is presented at another point in the UI based, at least in part, on the location information associated with the selected at least one of the one or more results. For example, a user selects a search result, “POI x”, wherein the search result is presented on a map application. Further, another search UI element is presented that is placed substantially near the same location in the UI where the UI element showing the search result for “POI x” is placed.

In one embodiment, a user conducts a search for a first POI (e.g., a restaurant) and receives one or more search results then, the applications 107 and/or a service provider cause a presentation and/or a suggestion of one or more information items on one or more other POIs which are near the location of the first POI and which are under one or more other categories (e.g., bars, shopping malls, coffee shops, etc.) Further, presentation and/or suggestion of other POIs may be by one or more service providers and may be based, at least in part, on a user history, user preferences, user calendar information and the like. For example, a user history may indicate that the user usually visits an art gallery after having dinner at a restaurant. In another example, a user is searching for a restaurant at city center and an entry in the user device calendar indicates an upcoming birthday for a friend wherein a service provider presents/suggests a shopping mall near the area where the user is searching for a restaurant. In one embodiment, a search by conducted when a user simply selects a category and a geographical area, for example, the user may select a “lodging” category and a desired city. In another embodiment, the location in a desired search may be user's current location, user's home location, location information collected from one or more applications 107 (e.g., a calendar application).

In another embodiment, another search query is generated which includes, at least in part, the another point as another search parameter. For example, (1) a search result indicating a first POI is presented on a map application, (2) a search UI element is presented on the map application substantially near where the first POI is shown, (3) the user causes another search query on another point (e.g., another POI). In another embodiment, one or more other results of the another search query are rendered in the user interface based, at in part, on other location information associated with the one or more other results. For example, a first POI is shown on a map application and one or more results on another POI are concurrently presented on the map application near the same location on the map application.

In one embodiment, another input for selecting at least another one of the one or more other results is determined. For example, a user selects one of the other results shown in a list and/or on a map application. In various embodiments, one or more itineraries and/or routing information based, at least in part, on the selected at least one result and the selected at least one other result are generated. For example, a user selects a first search result (e.g., a first POI), which may be presented on a map application via the UP, further, the user selects a second search result (e.g., a second POI), which may also be presented on the map application. Furthermore, the one or more applications (e.g., the map application) may utilize the information associated with the selected search results (e.g., the first and second POIs) for generating an itinerary and/or a routing information, which may be presented on the map application.

In various embodiments, a hierarchy of the search query, the one or more results, the selected at least one result, the another search query, the one or more other results, the selected at least one other result, or a combination thereof is determined. In one embodiment, a first search query is presented/placed (e.g., in 2D or 3D) at a higher position/level than a second search query. In another embodiment, the one or more results are presented/placed at different positions/levels corresponding to the one or more search queries. Further, the hierarchy is based, at least in part, on granularity information associated with the search query, the one or more results, the selected at least one result, the another search query, the one or more other results, the selected at least one other result, or a combination thereof.

In various embodiments, one or more rendering characteristics are determined for the one or more results, the selected at least one result, the one or more other results, the selected at least one other result, or a combination thereof based, at least in part, on the hierarchy. For example, a general geographical location for the one or more results and the one or more other results can be determined as a first level in a hierarchy for presentation of the results. In another example, the one or more results of a first search enquiry can be determined as a second level in the hierarchy. In various embodiments, the hierarchy may be determined by the user, a service provider, a user device configuration and the like. In various embodiments, the one or more results, the selected at least one result, the one or more other results, the selected at least one other result, or a combination thereof in the user interface are rendered based, at least in part, on the one or more rendering characteristics. For example, an overall location information for the one or more results and the one or more other results may indicate that the results are for a general geographical area (e.g., a city), which can be presented at a higher position/level on a map application. In another example, one or more results for a first search query (e.g., a first POI) may be placed below the general geographical area (e.g., a city) and above the one or more other results for a second search query (e.g., a second POI). In various embodiments, the user interface is a three-dimensional user interface, and wherein the one or more rendering characteristics include a z-axis displacement. For example, a map application renders an image of a geographical area wherein the objects in the map have different heights (e.g., in the z-axis direction) and wherein one or more tags are placed at different z-axis levels.

In another embodiment, the system 100 renders the active search UI element based on the three-dimensional (3D) direction along which a user device is pointed. More specifically, the system 100 utilizes augmented reality (e.g., using live or actual images of a location) or augmented virtual reality (e.g., using 3D models and 3D mapping information) to present a model of an map object (e.g., the Earth), seen in a first person view from the user device's current location so that the locations seen in the view match corresponding physical locations in reality. Although various embodiments are discussed with respect to the Earth as the three-dimensional map object, it is contemplated that the approach described herein is applicable to any map object including any real objects (e.g., a house, road, paper mill, etc.) and/or virtual objects (e.g., planned architectural models, renderings of fictitious objects, game environments, fictional environments, etc.). In one embodiment, a search is initiated when the system 100 receives an input from the active search UI element in, for instance, a user equipment 101 and determines available location information based, at least in part, on the input Once the location information is verified and availability of the location information is determined, the system 100 generates a user interface to present the location information via the active search UI element as discussed above. By way of example, the location information may indicate: (1) a location of a point of interest (POI) that is a result of a search, (2) a location where the information relating to the item was captured, e.g., geo-tagged data, and (3) a location of a provider of the information, or any other data or information that include or are otherwise associated with one or more results of the search. It is also contemplated that the desired information item may be associated with multiple locations.

As shown in FIG. 1, the user equipment (UE) 101 may retrieve location information and mapping information (e.g., global maps, 3D maps, first person augmented reality views, etc.) associated with one or more point of interest (POI) from an information provider 115 and/or information mapping platform 103 via a communication network 105. The location information and mapping information can be used by an application 107 on the UE 101 (e.g., an augmented reality application, navigation application, or other location-based application). In the example of FIG. 1, the information mapping platform 103 stores location information in the information catalog 109a and mapping information in the map database 109b. By way of example, location information includes one or more identifiers, physical world addresses, metadata, map addresses and the like. In one embodiment, desired information items are related to points of interest (POI) in one or more geographical areas, under one or more categories and the like. The desired information items may be searched for by a user and/or an application and can be provided by a service platform 111 which includes one or more services 113a-113n (e.g., music service, mapping service, video service, social networking service, information broadcasting service, etc.), the one or more information providers 115a-115m (e.g., online retailers, public databases, etc.), or any other information source available, or accessible, over the communication network 105.

In certain embodiments, the mapping information and the maps presented to the user may be an augmented reality view, a simulated 3D environment, a two-dimensional map, a document (e.g., a word processing document, an image, a video, etc.), or the like. In certain embodiments, the simulated 3D environment is a 3D model created to approximate the locations of streets, buildings, features, etc. of an area. This model can then be used to render the location from virtually any angle or perspective for display on the UE 101. In some programs (e.g., navigation application 107), the 3D model or environment enables, for instance, the navigation application 107 to animate movement through the 3D environment to provide a more dynamic and potentially more useful or interesting mapping display to the user. In one embodiment, structures are stored using simple objects (e.g., three dimensional models describing the dimensions of the structures). Further, more complex objects may be utilized to represent structures and other objects within the 3D representation. Complex objects may include multiple smaller or simple objects dividing the complex objects into portions or elements. To create the 3D model, object information can be collected from various databases as well as data entry methods such as processing images associated with location stamps to determine structures and other objects in the 3D model.

In addition or alternatively, the mapping information may be displayed using other user interfaces such as audio interfaces, haptic feedback, and other sensory interfaces. For example, in an audio presentation of the mapping information, the approximate locations of streets, buildings, features, points of interest, desired information items, etc. can be read aloud by a voice synthesizer executing on the UE 101.

Additionally or alternatively, in certain embodiments, an image capture module 117 of the UE 101 may be utilized in conjunction with the application 107 to present location information (e.g., mapping and navigation information) to the user. The user may be presented with an augmented reality interface associated with the application 107 and/or the information mapping platform allowing 3D objects or other representations of desired information and related information to be superimposed onto an image of a physical environment on the UE 101. In certain embodiments, the user interface may display a hybrid physical and virtual environment where 3D objects from the map database 109 are placed superimposed on top of a physical image.

By way of example, the UE 101 may execute the application 107 to query for a desired information item and/or mapping information from the information mapping platform 103 or other component of the network 105.

Moreover, map information stored in the map database 109b may be created from 3D models of real-world buildings and other sites. As such, objects can be associated with real world locations (e.g., based on location coordinates such as global positioning system (GPS) coordinates). In certain embodiments, the UE 101 may utilize GPS satellites 119 to determine the location of the UE 101 to utilize the information mapping functions of the information mapping platform 103 and/or the application 107. The map information may include a 3D model (e.g., a complex 3D model) of objects and structures in a physical environment (e.g., buildings) made up of a number of separate but adjoined simple 3D shapes such as polygons. Conventional approaches of 3D modeling include the ability to access and transform each polygon in size and shape separately from the other polygons that form the complete 3D model of the object.

By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of immobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof including the accessories and peripherals of these devices, or any combination thereof. It is also contemplated that the UE 101 can support any type of interface to the user (such as “wearable” circuitry, etc.). In one embodiment, the UE 101 can be a device that simulates or provides a virtual telescope-like function. This type of UE 101 can be, for instance, mounted in a public place (e.g., a shopping center, hotel, etc.) to enable users to view information presented as described herein.

By way of example, the UE 101, and information mapping platform 103 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

In one embodiment, the application 107 and the information mapping platform 103 may interact according to a client-server model. According to the client-server model, a client process sends a message including a request to a server process, and the server process responds by providing a service (e.g., providing map information). The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others.

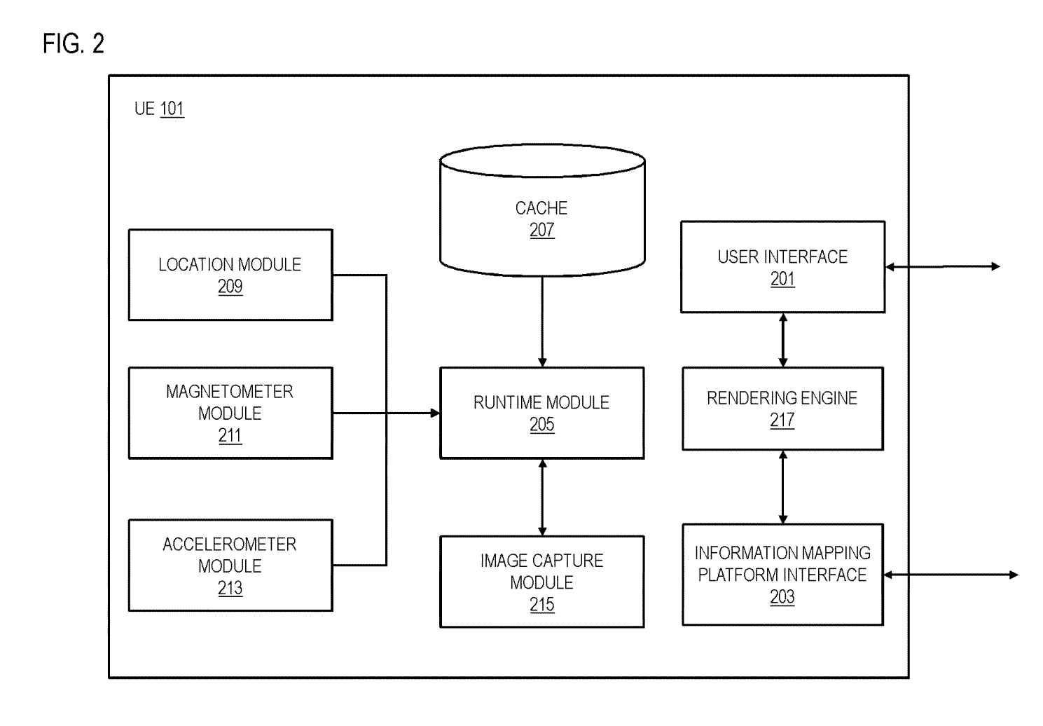

FIG. 2 is a diagram of the components of user equipment capable of presenting an active user interface element, according to one embodiment. By way of example, the UE 101 includes one or more components for presenting desired information and location information accessible over the communication network 105 via the active search UI element. It is contemplated that the functions of these components may be combined in one or more components or performed by other components of equivalent functionality. In this embodiment, the UE 101 includes a user interface 201 to present information and receive input, an information mapping platform interface 203 to retrieve information and mapping information from the information mapping platform 103, a runtime module 205, a cache 207 to locally store information and mapping information, a location module 209 to determine a location of the UE 101, a magnetometer module 211 to determine horizontal orientation or directional heading (e.g., a compass heading) of the UE 101, an accelerometer module 213 to determine vertical orientation or an angle of elevation of the UE 101, and an image capture module 117.

The active search UI element, related results, and/or mapping information may be presented to the user via the user interface 201, which may include various methods of communication. For example, the user interface 201 can have outputs including a visual component (e.g., a screen), an audio component (e.g., a verbal instructions), a physical component (e.g., vibrations), and other methods of communication. User inputs can include a touch-screen interface, microphone, camera, a scroll-and-click interface, a button interface, etc. Further, the user may input a request to start an application 107 (e.g., a mapping or augmented reality application) and utilize the user interface 201 to receive information and mapping information. Through the user interface 201, the user may request different types of information items, mapping, or location information to be presented. Further, the user may be presented with 3D or augmented reality representations of particular locations and related objects (e.g., buildings, terrain features, POIs, etc. at the particular location) as part of a graphical user interface on a screen of the UE 101.

The information mapping platform interface 203 is used by the runtime module 205 to communicate with the information mapping platform 103. In some embodiments, the interface is used to fetch information items, mapping, and or location information from the information mapping platform 103, service platform 111, and/or information providers 115a-115m. The UE 101 may utilize requests in a client server format to retrieve the information items and mapping information. Moreover, the UE 101 may specify location information and/or orientation information in the request to retrieve the information items and mapping information. The location module 209, magnetometer module 211, accelerometer module 213, and image capture module 117 may be utilized to determine location and/or orientation information. Further, this information and mapping information may be stored in the cache 207 to be utilized in presenting a map view of desired information at the UE 101.

In one embodiment, the location module 209 can determine a user's location. The user's location can be determined by a triangulation system such as a GPS, assisted GPS (A-GPS) A-GPS, Cell of Origin, wireless local area network triangulation, or other location extrapolation technologies. Standard GPS and A-GPS systems can use satellites 119 to pinpoint the location (e.g., longitude, latitude, and altitude) of the UE 101. A Cell of Origin system can be used to determine the cellular tower that a cellular UE 101 is synchronized with. This information provides a coarse location of the UE 101 because the cellular tower can have a unique cellular identifier (cell-ID) that can be geographically mapped. The location module 209 may also utilize multiple technologies to detect the location of the UE 101. GPS coordinates can provide finer detail as to the location of the UE 101. As previously noted, the location module 209 may be utilized to determine location coordinates for use by the application 107 and/or the information mapping platform 103.

The magnetometer module 211 can include an instrument that can measure the strength and/or direction of a magnetic field. Using the same approach as a compass, the magnetometer is capable of determining the directional heading of a UE 101 using the magnetic field of the Earth. The front of the image capture device (e.g., a digital camera) (or another reference point on the UE 101) can be marked as a reference point in determining direction. Thus, if the magnetic field points north compared to the reference point, the angle the UE 101 reference point is from the magnetic field is known. Simple calculations can be made to determine the direction of the UE 101. In one embodiment, horizontal directional data obtained from a magnetometer is utilized to determine the orientation of the user. This information may be utilized to select a first person view to render desired information and mapping information.

Further, the accelerometer module 213 may include an instrument that can measure acceleration. Using a three-axis accelerometer, with axes X, Y, and Z, provides the acceleration in three directions with known angles. Once again, the front of a media capture device can be marked as a reference point in determining direction. As such, this information may be utilized in selecting available information items to present navigational information to the user. Moreover, the combined information may be utilized to determine portions of a particular 3D map or augmented reality view that may interest the user. User defined images for supporting a graphical user interface can be captured using an image capture module 215. An image capture module 215 may include a camera, a video camera, a combination thereof, etc. In one embodiment, visual media is captured in the form of an image or a series of images. The image capture module 215 can obtain the image from a camera and associate the image with location information, magnetometer information, accelerometer information, or a combination thereof. This information may be utilized to retrieve a desired information item and mapping information from the map cache 207 or the mapping platform 103. In certain embodiments, the cache 207 includes all or a portion of the information in the information catalog 109a and the map database 109b.

Further, the information mapping platform interface 203 then interacts with the rendering engine 217 to present the location information of the desired information, and other information related to the desired information using any type of visual user interface (e.g., augmented reality view, 3D maps, etc.), audio user interface, tactile or tangible user interface (e.g., haptic feedback), or any possible user interface or combination of user interface types.

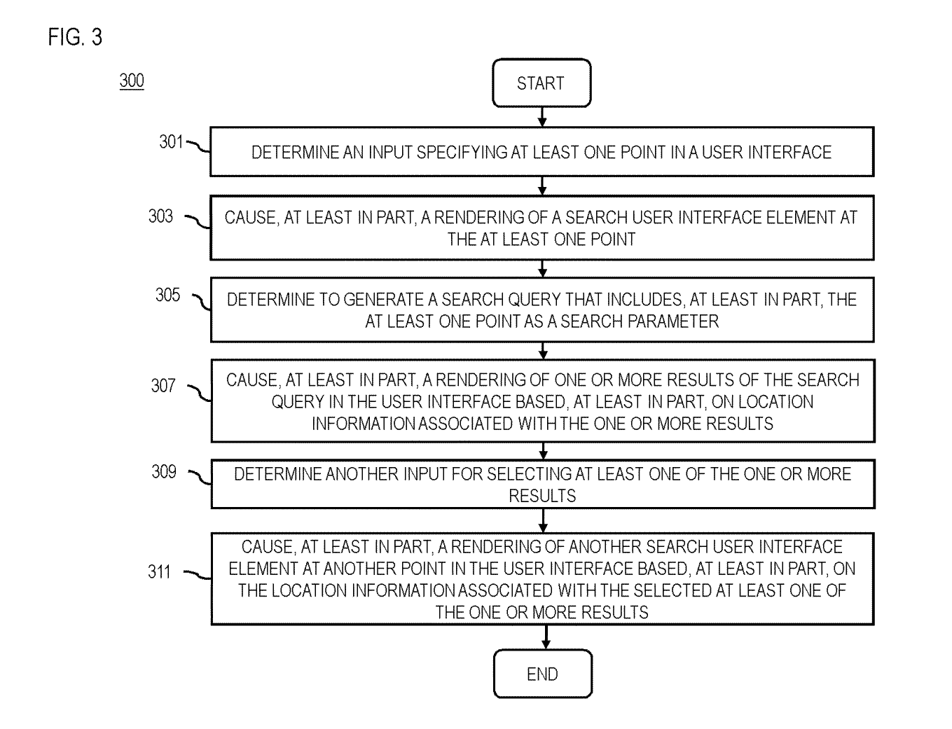

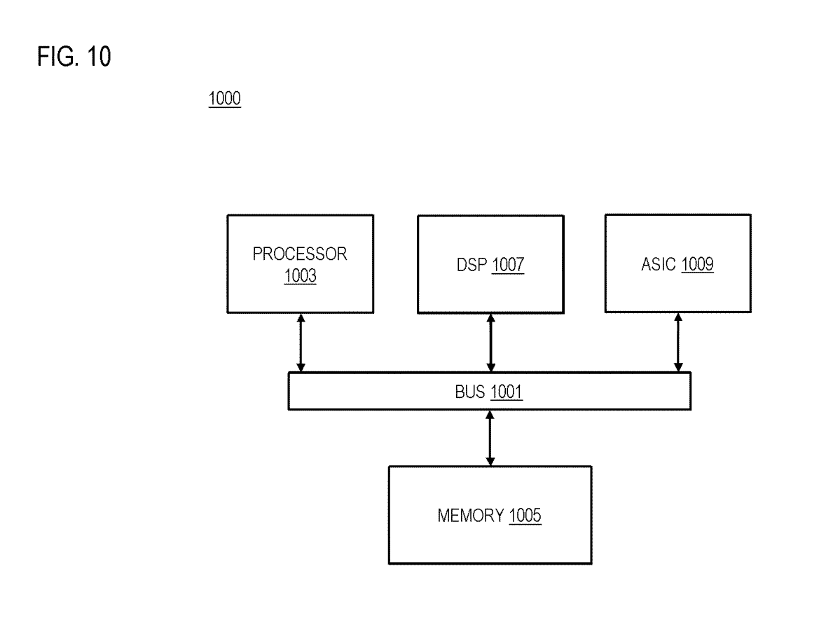

FIG. 3 is a flowchart of a process for determining a search query and rendering one or more search results, according to one embodiment. In one embodiment, the runtime module 205 performs the process 300 and is implemented in, for instance, a chip set including a processor and a memory as shown FIG. 10. In certain embodiments, the information mapping platform 103 may perform some or all of the steps of the process 300 and communicate with the UE 101 using a client server interface. The UE 101 may activate an application 107 to utilize information mapping services of the information mapping platform 103. Moreover, the application 107 may execute upon the runtime module 205.

In step 301, the runtime module 905 determines an input specifying at least one point in a user interface (UI). In one embodiment, a user and/or an application 107 enters/submits one or more search terms (e.g., restaurants) via a UI search element (e.g., at a designated text box).

In step 303, the runtime module 905 causes, at least in part, a rendering of a search user interface element at the at least one point. In one embodiment, a search UI element is rendered at the at least one point. For example, a UI element is presented to the user for entering text wherein the UI element is substantially at the same location as the first UI element, wherein the user interface includes, at least in part, a selection of one or more category-based search terms.

In step 305, the runtime module 905 determines to generate a search query that includes, at least in part, the at least one point as a search parameter. In one embodiment, a search query including the at least one point as a search parameter is generated. For example, the search terms of the first UI element are utilized to generate a search query wherein the search query includes, at least in part, a location-based query, an information query, a web query, or a combination thereof and wherein the user interface is for, at least in part, a mapping application, a navigation application, an augmented reality application, a virtual reality application, or a combination thereof.

In step 307, the runtime module 905 causes, at least in part, a rendering of one or more results of the search query in the user interface based, at least in part, on location information associated with the one or more results. In one embodiment, location information associated with the one or more search results (e.g., POIs) are utilized to locate and present them on a map application.

In step 309, the runtime module 905 determines another input for selecting at least one of the one or more results. In one embodiment, multiple search results are presented to the user which may be via a listing and/or on a map application indicating location of the search results on the map application wherein the user selects (e.g., clicks on) at least one of the search result items.

In step 311, the runtime module 905 causes, at least in part, a rendering of another search user interface element at another point in the user interface based, at least in part, on the location information associated with the selected at least one of the one or more results. In one embodiment, another UI element substantially close to the location of the selected search item in the list and/or on the map is presented to the user. For example, multiple POIs are presented on the map application wherein the user selects one of the POIs. Further, another UI search element (e.g., a text box) is presented on the map application substantially close to the location of the POI on the map.

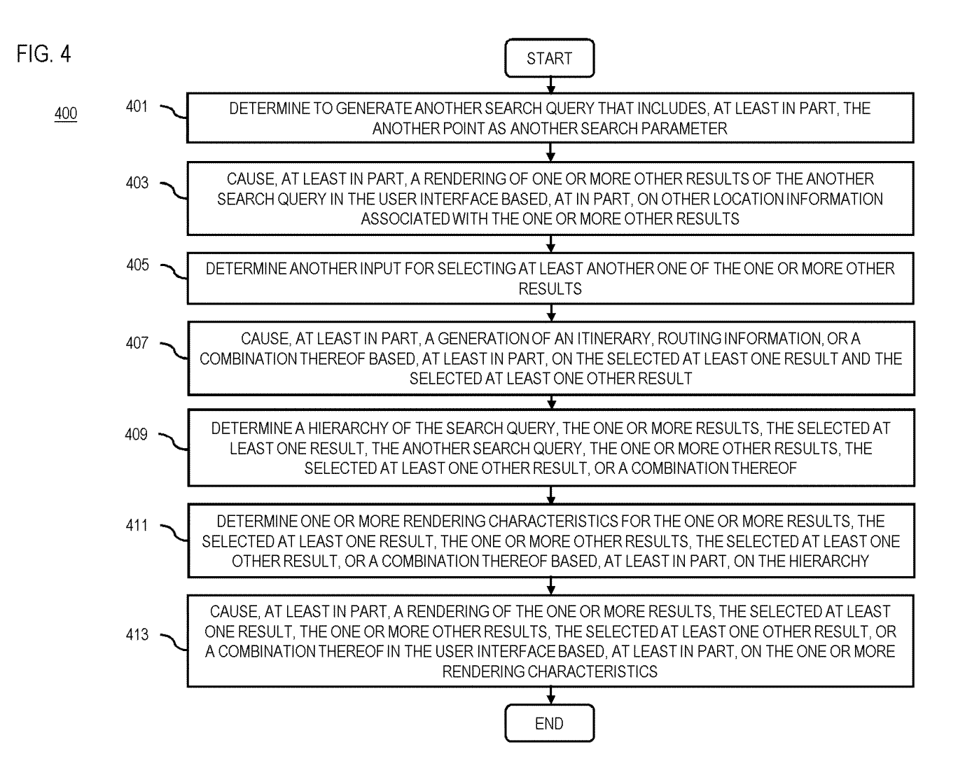

FIG. 4 is a flowchart of a process for determining another search query and rendering one or more other search results, according to one embodiment. In one embodiment, the runtime module 205 performs the process 400 and is implemented in, for instance, a chip set including a processor and a memory as shown FIG. 10. In certain embodiments, the information mapping platform 103 may perform some or all of the steps of the process 400 and communicate with the UE 101 using a client server interface. The UE 101 may activate an application 107 to utilize information mapping services of the information mapping platform 103. Moreover, the application 107 may execute upon the runtime module 205.

In step 401, the runtime module 905 determines to generate another search query that includes, at least in part, the another point as another search parameter. In one embodiment, one or more other search queries are initiated which include another search parameter. For example, another search parameter (e.g., bars located near a certain location on the map) is submitted into another UI search element.

In step 403, the runtime module 905 causes, at least in part, a rendering of one or more other results of the another search query in the user interface based, at in part, on other location information associated with the one or more other results. In one embodiment, one or more new/other search results are presented to the user which may be in addition to the search results presented earlier.

In step 405, the runtime module 905 determines another input for selecting at least another one of the one or more other results. In one embodiment, the user may select one of the one or more newly presented search results. For example, earlier the user may have selected a certain restaurant from a multiple of choices and then may select a “bar” from a list of “bars” located and presented on the map application.

In step 407, the runtime module 905 causes, at least in part, a generation of an itinerary, routing information, or a combination thereof based, at least in part, on the selected at least one result and the selected at least one other result. In one embodiment, the user selects a first POI on the map and/or on a list and then selects a second POI on the map and/or on a list. Further, one or more applications 107 (e.g., navigation, calendar, web browser, etc.) may utilize the location information for the two POIs in order to generate one or more itineraries, calendar entries, navigation routing and the like, which the user may utilize and/or save at the user device and/or at a service provider for future use.

In step 409, the runtime module 905 determines a hierarchy of the search query, the one or more results, the selected at least one result, the another search query, the one or more other results, the selected at least one other result, or a combination thereof. In one embodiment, the search results and/or the search queries are presented on the map application and/or on a list based on one or more criteria, which may be defined by the application 107, information provider 115, service platform 111, the user or a combination thereof. Further, the hierarchy is based, at least in part, on granularity information associated with the search query, the one or more results, the selected at least one result, the another search query, the one or more other results, the selected at least one other result, or a combination thereof.

In step 411, the runtime module 905 determines one or more rendering characteristics for the one or more results, the selected at least one result, the one or more other results, the selected at least one other result, or a combination thereof based, at least in part, on the hierarchy. For example, the hierarchy may be based on country, state, city, proximity to user location, ranking, extent of available information associated with the search results or a combination thereof.

In step 413, the runtime module 905 causes, at least in part, a rendering of the one or more results, the selected at least one result, the one or more other results, the selected at least one other result, or a combination thereof in the user interface based, at least in part, on the one or more rendering characteristics. In one embodiment, positions on a map application and/or on a list at which the search results and/or search queries are presented correlate to the determined hierarchy. For example, location information/tags associated with a search result item may be shown from highest to lowest as state, county, city, category and the like. In another the user interface is a three-dimensional user interface, and wherein the one or more rendering characteristics include a z-axis displacement.

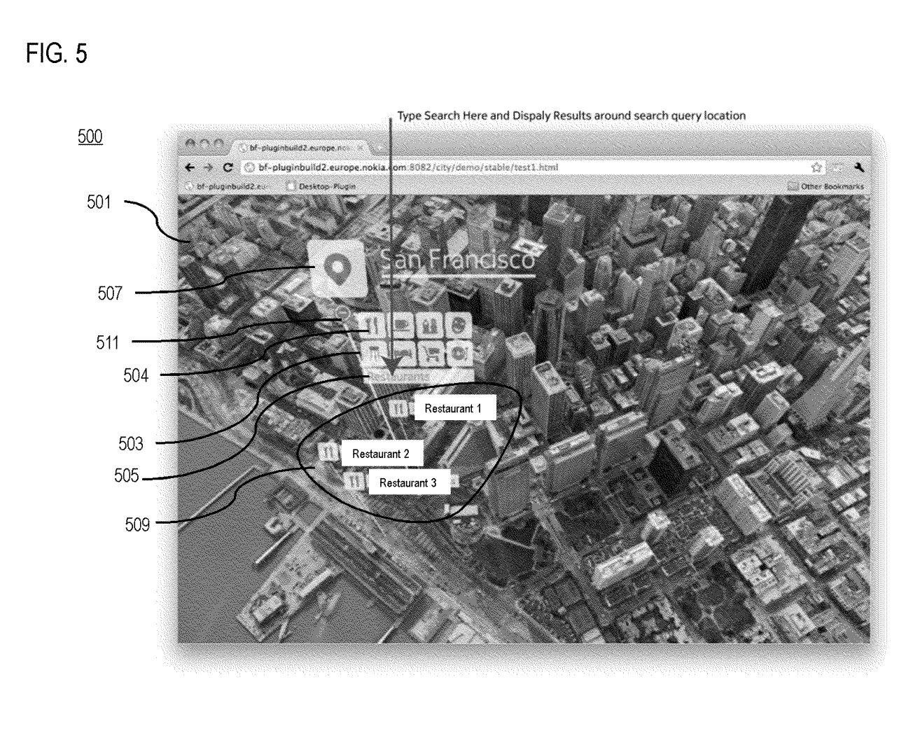

FIGS. 5-8 are diagrams that illustrate example user interfaces used in the process of FIGS. 3 and 4, according to various embodiments. FIG. 5 shows a user interface (UI) 500, which in this exemplary embodiment, may be a UI for a search application and/or may be launched in response to a request for a search initiated by the a user and/or an application 107. In this example a map 501 is illustrated which may be limited to a default range around the location of the user device, or around a selected starting position for viewing. The range, however, may be adjustable to expand or reduce the scope of the view available on the user interface 500 around any location. The user interface 501 has a category section 503 which may have one or more categories such as restaurant, bars, theaters, music stores, book stores, shopping stores and the like. Further, search box, or element, 505 may be positioned near a geographic region 507 (e.g., city of San Francisco), which may be the center of search in this example. The search box 505 and the category section 503 may be fixed or be moveable to any location on the user interface 501, or their general shape and/or arrangement may be changeable as well. The search results grouped in 509 may include one or more search results which may be further identified by one or more associated data (e.g., restaurant 1, restaurant 2, etc.) presented on the map application indicated by one or more indicators such as a pin, a dot, a flag, a dart, and the like. It is noted that in this example, a hierarchy for presenting available information on the map application indicates the search region 507, the search category 503, the search element box 505 and the one or more search results 509. Further, the hierarchy may be defined by the user, by a service provider, by the application 107 or a combination thereof. In this example, a user has selected the search category 504 corresponding to “restaurants”, which caused an entry of “Restaurants” into the search element box 505. Indicator 511 points to a UI element which indicates that there are multiple elements within the category, wherein in this example, there are eight different categories such as restaurants, shopping, bars, lodging, theaters, etc. In one embodiment, the search results and/or information items may be animated to appear and disappear periodically to display additional information. Additionally, the amount of information shown can be restricted, reduced and/or sequentially displayed (e.g., using adjustable zoom or detail levels) so that information labels do not obscure and interfere with other information present on the map.

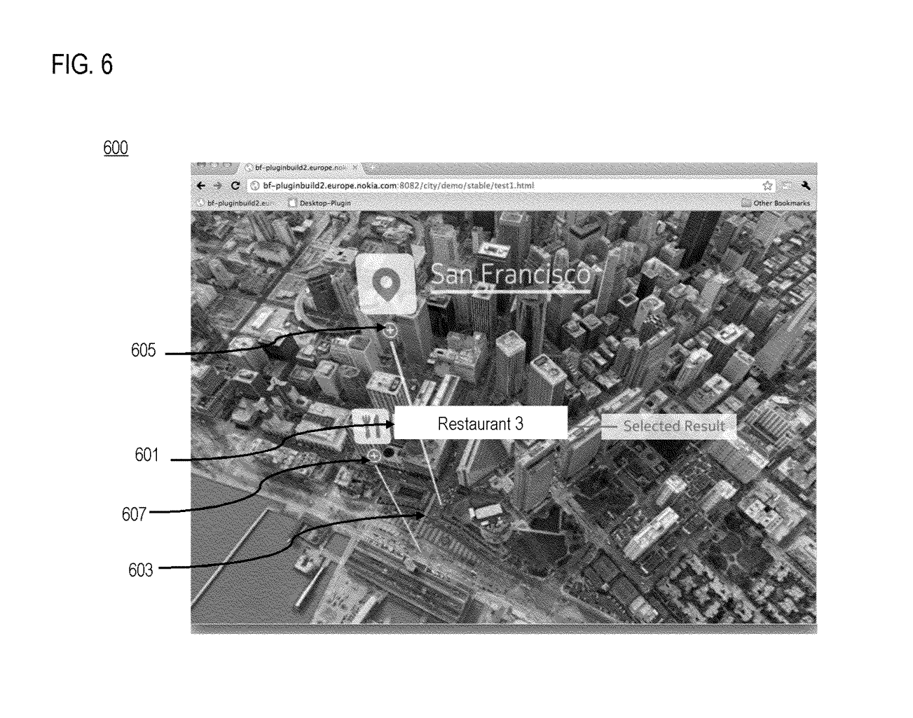

FIG. 6 depicts UI 600 which indicates that a search result 601 (e.g., restaurant 3) has been selected, which may cause application 107 to present a navigation route 603. Further, indicator 605 changes from a minus sign in a circle in FIG. 5 to a plus sign in a circle indicating that the categories section has been grouped and hidden from view (e.g., to avoid clutter). Also, indicator 607 points to one or more other search result elements which have been grouped and hidden from view. It is noted that the user and/or one or more applications can cause the hidden items/groups (605, 607) to ungroup and/or present for viewing again. In various embodiments, the search results may be highlighted and/or otherwise dynamically modified to provide different visual effects and information to maintain user interest and/or effectively present a useful display of the information, for example, clear, uncluttered, scaled, color coded and the like.

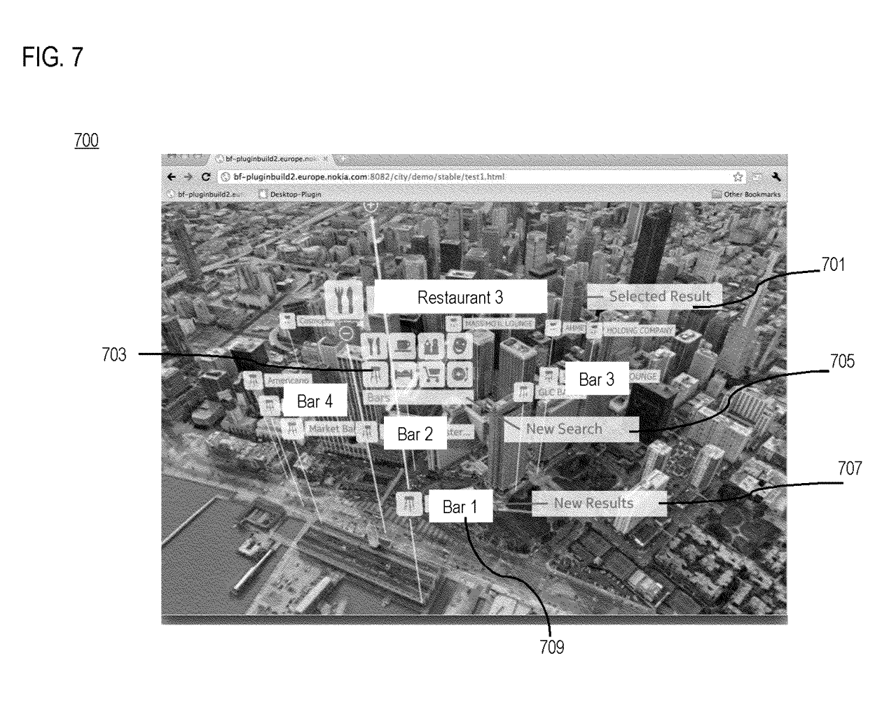

FIG. 7 depicts UI 700 which indicates the selected search result 701 (e.g., restaurant 3) and presents the categories selection wherein the user selects 703 for conducting a new search 705 under the “Bars” category which may be near the selection 701. Indicator 707 points to one or more new search results (e.g., Bar 1, Bar 2, Bar 3, etc.) for the search under the “Bars” category, wherein 709 points to a search result element “Bar 1”. It is noted that the order of searching and selection of the one or more search results may be varied and carried out by the user and/or one or more applications on the user device and/or by a service provider.

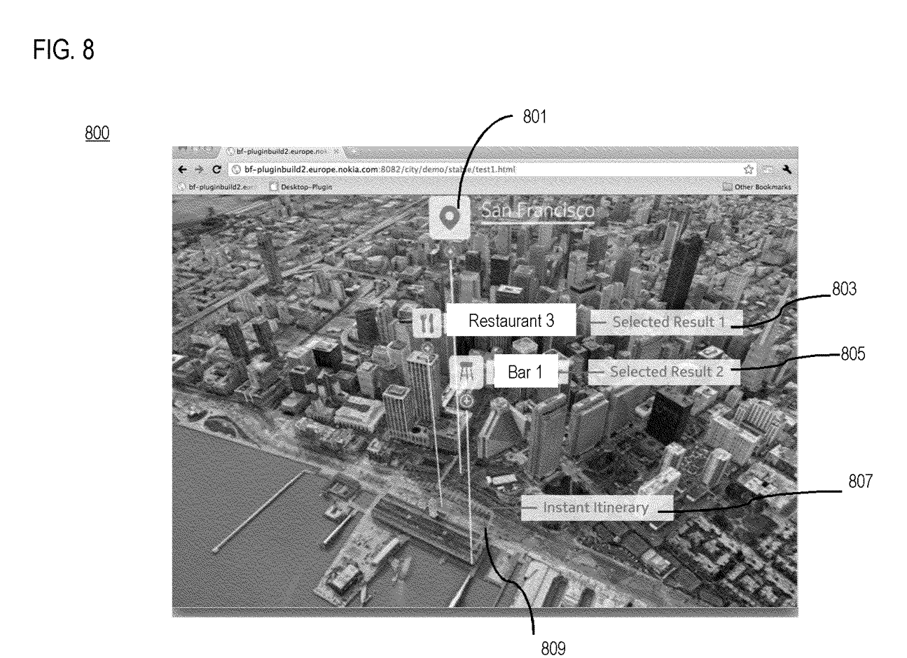

FIG. 8 depicts UI 800 illustrating example search results for the desired information items wherein a user has selected two search results 803 (Restaurant 3) and 805 (Bar 1) in a geographic area 801 (San Francisco) and an instant itinerary 807 as well as a navigation route 809 are generated and presented on a map application. It is noted that although this example illustrates a 3D image on a map application, the methods can be equally applied to AR, MR and 2D renderings.

By way of example, FIGS. 5-8 illustrate views of a map application wherein the search results and information items are presented from a top-view perspective; however, same information can be presented in other views of the map the application. For example, if the user chooses a street-view, then the search results and related information can be presented such that the user can still ascertain the same information, for example, hierarchy, distance between two POIs, navigation information, selection of search results and categories and the like. Additionally, depending on scaling in the map application, the search results and related information can be dynamically adjusted so to maintain a minimum level in the quality in the presentation of the search results and the related information. For example, the user may wish to expand or reduce the area of interest while conducting one or more searches.

Furthermore, from selected scaling and viewpoint, an image representing an augmented reality view or a 3D model of the location corresponding to the viewpoint can be generated or retrieved from the cache 207 or the information mapping platform 103. As previously noted, the image may represent a physical environment, which may be captured using an image capture module 117 of the UE 101. In another embodiment, the image may represent a virtual 3D environment, where the user's location in the real world physical environment is represented in the virtual 3D environment. In the representation, the viewpoint of the user is mapped onto the virtual 3D environment. Moreover, a hybrid physical and virtual 3D environment may additionally be utilized to present navigational information to the user.

The processes described herein for presenting search results in an active user interface element may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

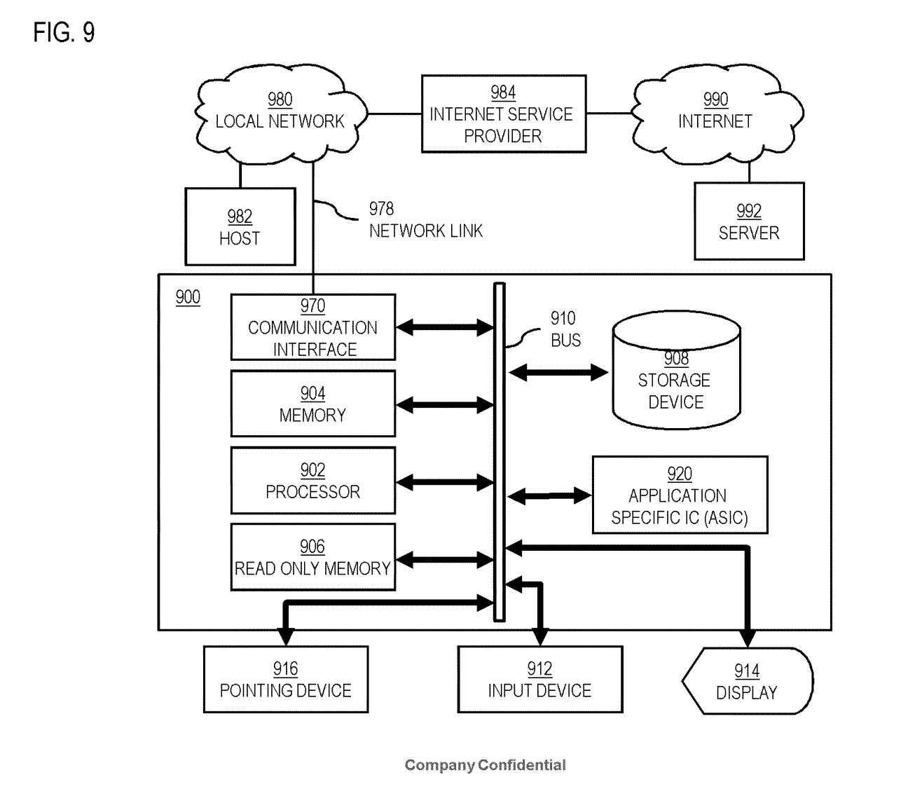

FIG. 9 illustrates a computer system 900 upon which an embodiment of the invention may be implemented. Although computer system 900 is depicted with respect to a particular device or equipment, it is contemplated that other devices or equipment (e.g., network elements, servers, etc.) within FIG. 9 can deploy the illustrated hardware and components of system 900. Computer system 900 is programmed (e.g., via computer program code or instructions) to present search results in an active user interface element as described herein and includes a communication mechanism such as a bus 910 for passing information between other internal and external components of the computer system 900. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 900, or a portion thereof, constitutes a means for performing one or more steps of presenting search results in an active user interface element.

A bus 910 includes one or more parallel conductors of information so that information is transferred quickly among devices coupled to the bus 910. One or more processors 902 for processing information are coupled with the bus 910.

A processor 902 performs a set of operations on information as specified by computer program code related to presenting search results in an active user interface element. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 910 and placing information on the bus 910. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 902, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 900 also includes a memory 904 coupled to bus 910. The memory 904, such as a random access memory (RAM) or other dynamic storage device, stores information including processor instructions for presenting search results in an active user interface element. Dynamic memory allows information stored therein to be changed by the computer system 900. RAM allows a unit of information stored at a location called a memory address to be stored and retrieved independently of information at neighboring addresses. The memory 904 is also used by the processor 902 to store temporary values during execution of processor instructions. The computer system 900 also includes a read only memory (ROM) 906 or other static storage device coupled to the bus 910 for storing static information, including instructions, that is not changed by the computer system 900. Some memory is composed of volatile storage that loses the information stored thereon when power is lost. Also coupled to bus 910 is a non-volatile (persistent) storage device 908, such as a magnetic disk, optical disk or flash card, for storing information, including instructions, that persists even when the computer system 900 is turned off or otherwise loses power.

Information, including instructions for presenting search results in an active user interface element, is provided to the bus 910 for use by the processor from an external input device 912, such as a keyboard containing alphanumeric keys operated by a human user, or a sensor. A sensor detects conditions in its vicinity and transforms those detections into physical expression compatible with the measurable phenomenon used to represent information in computer system 900. Other external devices coupled to bus 910, used primarily for interacting with humans, include a display device 914, such as a cathode ray tube (CRT) or a liquid crystal display (LCD), or plasma screen or printer for presenting text or images, and a pointing device 916, such as a mouse or a trackball or cursor direction keys, or motion sensor, for controlling a position of a small cursor image presented on the display 914 and issuing commands associated with graphical elements presented on the display 914. In some embodiments, for example, in embodiments in which the computer system 900 performs all functions automatically without human input, one or more of external input device 912, display device 914 and pointing device 916 is omitted.

In the illustrated embodiment, special purpose hardware, such as an application specific integrated circuit (ASIC) 920, is coupled to bus 910. The special purpose hardware is configured to perform operations not performed by processor 902 quickly enough for special purposes. Examples of application specific ICs include graphics accelerator cards for generating images for display 914, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 900 also includes one or more instances of a communications interface 970 coupled to bus 910. Communication interface 970 provides a one-way or two-way communication coupling to a variety of external devices that operate with their own processors, such as printers, scanners and external disks. In general the coupling is with a network link 978 that is connected to a local network 980 to which a variety of external devices with their own processors are connected. For example, communication interface 970 may be a parallel port or a serial port or a universal serial bus (USB) port on a personal computer. In some embodiments, communications interface 970 is an integrated services digital network (ISDN) card or a digital subscriber line (DSL) card or a telephone modem that provides an information communication connection to a corresponding type of telephone line. In some embodiments, a communication interface 970 is a cable modem that converts signals on bus 910 into signals for a communication connection over a coaxial cable or into optical signals for a communication connection over a fiber optic cable. As another example, communications interface 970 may be a local area network (LAN) card to provide a data communication connection to a compatible LAN, such as Ethernet. Wireless links may also be implemented. For wireless links, the communications interface 970 sends or receives or both sends and receives electrical, acoustic or electromagnetic signals, including infrared and optical signals that carry information streams, such as digital data. For example, in wireless handheld devices, such as mobile telephones like cell phones, the communications interface 970 includes a radio band electromagnetic transmitter and receiver called a radio transceiver. In certain embodiments, the communications interface 970 enables connection to the communication network 105 for presenting search results in an active user interface element.

The term “computer-readable medium” as used hereinto refers to any medium that participates in providing information to processor 902, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 908. Volatile media include, for example, dynamic memory 904. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 920.

Network link 978 typically provides information communication using transmission media through one or more networks to other devices that use or process the information. For example, network link 978 may provide a connection through local network 980 to a host computer 982 or to equipment 984 operated by an Internet Service Provider (ISP). ISP equipment 984 in turn provides data communication services through the public, world-wide packet-switching communication network of networks now commonly referred to as the Internet 990.

A computer called a server host 992 connected to the Internet hosts a process that provides a service in response to information received over the Internet. For example, server host 992 hosts a process that provides information representing video data for presentation at display 914. It is contemplated that the components of system 900 can be deployed in various configurations within other computer systems, e.g., host 982 and server 992.

At least some embodiments of the invention are related to the use of computer system 900 for implementing some or all of the techniques described herein. According to one embodiment of the invention, those techniques are performed by computer system 900 in response to processor 902 executing one or more sequences of one or more processor instructions contained in memory 904. Such instructions, also called computer instructions, software and program code, may be read into memory 904 from another computer-readable medium such as storage device 908 or network link 978. Execution of the sequences of instructions contained in memory 904 causes processor 902 to perform one or more of the method steps described herein. In alternative embodiments, hardware, such as ASIC 920, may be used in place of or in combination with software to implement the invention. Thus, embodiments of the invention are not limited to any specific combination of hardware and software, unless otherwise explicitly stated herein.

The signals transmitted over network link 978 and other networks through communications interface 970, carry information to and from computer system 900. Computer system 900 can send and receive information, including program code, through the networks 980, 990 among others, through network link 978 and communications interface 970. In an example using the Internet 990, a server host 992 transmits program code for a particular application, requested by a message sent from computer 900, through Internet 990, ISP equipment 984, local network 980 and communications interface 970. The received code may be executed by processor 902 as it is received, or may be stored in memory 904 or in storage device 908 or other non-volatile storage for later execution, or both. In this manner, computer system 900 may obtain application program code in the form of signals on a carrier wave.

Various forms of computer readable media may be involved in carrying one or more sequence of instructions or data or both to processor 902 for execution. For example, instructions and data may initially be carried on a magnetic disk of a remote computer such as host 982. The remote computer loads the instructions and data into its dynamic memory and sends the instructions and data over a telephone line using a modem. A modem local to the computer system 900 receives the instructions and data on a telephone line and uses an infra-red transmitter to convert the instructions and data to a signal on an infra-red carrier wave serving as the network link 978. An infrared detector serving as communications interface 970 receives the instructions and data carried in the infrared signal and places information representing the instructions and data onto bus 910. Bus 910 carries the information to memory 904 from which processor 902 retrieves and executes the instructions using some of the data sent with the instructions. The instructions and data received in memory 904 may optionally be stored on storage device 908, either before or after execution by the processor 902.

FIG. 10 illustrates a chip set 1000 upon which an embodiment of the invention may be implemented. Chip set 1000 is programmed to present search results in an active user interface element as described herein and includes, for instance, the processor and memory components described with respect to FIG. 9 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 1000, or a portion thereof, constitutes a means for performing one or more steps of presenting search results in an active user interface element.

In one embodiment, the chip set 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform the inventive steps described herein to present search results in an active user interface element. The memory 1005 also stores the data associated with or generated by the execution of the inventive steps.

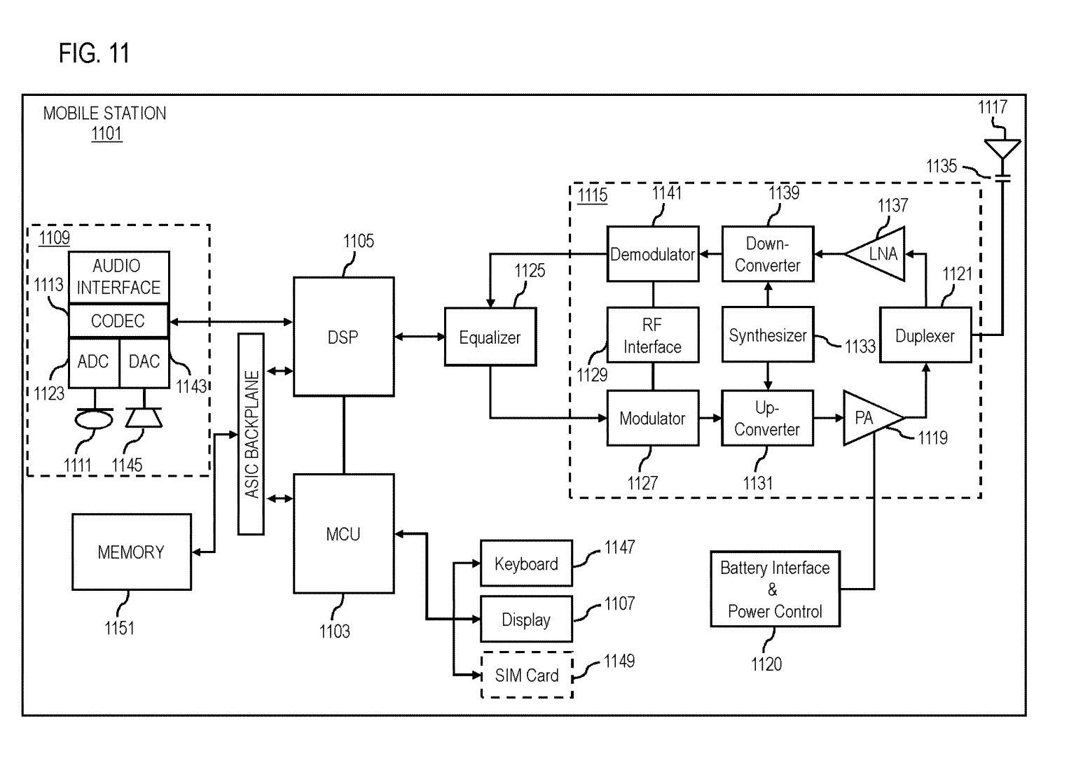

FIG. 11 is a diagram of exemplary components of a mobile terminal (e.g., handset) for communications, which is capable of operating in the system of FIG. 1, according to one embodiment. In some embodiments, mobile terminal 1100, or a portion thereof, constitutes a means for performing one or more steps of presenting search results in an active user interface element. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile device or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile device or a similar integrated circuit in a cellular network device or other network devices.

Pertinent internal components of the telephone include a Main Control Unit (MCU) 1103, a Digital Signal Processor (DSP) 1105, and a receiver/transmitter unit including a microphone gain control unit and a speaker gain control unit. A main display unit 1107 provides a display to the user in support of various applications and mobile terminal functions that perform or support the steps of presenting search results in an active user interface element. The display 1107 includes display circuitry configured to display at least a portion of a user interface of the mobile terminal (e.g., mobile telephone). Additionally, the display 1107 and display circuitry are configured to facilitate user control of at least some functions of the mobile terminal. An audio function circuitry 1109 includes a microphone 1111 and microphone amplifier that amplifies the speech signal output from the microphone 1111. The amplified speech signal output from the microphone 1111 is fed to a coder/decoder (CODEC) 1113.

A radio section 1115 amplifies power and converts frequency in order to communicate with a base station, which is included in a mobile communication system, via antenna 1117. The power amplifier (PA) 1119 and the transmitter/modulation circuitry are operationally responsive to the MCU 1103, with an output from the PA 1119 coupled to the duplexer 1121 or circulator or antenna switch, as known in the art. The PA 1119 also couples to a battery interface and power control unit 1120.

In use, a user of mobile terminal 1101 speaks into the microphone 1111 and his or her voice along with any detected background noise is converted into an analog voltage. The analog voltage is then converted into a digital signal through the Analog to Digital Converter (ADC) 1123. The control unit 1103 routes the digital signal into the DSP 1105 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UNITS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like.

The encoded signals are then routed to an equalizer 1125 for compensation of any frequency-dependent impairments that occur during transmission though the air such as phase and amplitude distortion. After equalizing the bit stream, the modulator 1127 combines the signal with a RF signal generated in the RF interface 1129. The modulator 1127 generates a sine wave by way of frequency or phase modulation. In order to prepare the signal for transmission, an up-converter 1131 combines the sine wave output from the modulator 1127 with another sine wave generated by a synthesizer 1133 to achieve the desired frequency of transmission. The signal is then sent through a PA 1119 to increase the signal to an appropriate power level. In practical systems, the PA 1119 acts as a variable gain amplifier whose gain is controlled by the DSP 1105 from information received from a network base station. The signal is then filtered within the duplexer 1121 and optionally sent to an antenna coupler 1135 to match impedances to provide maximum power transfer. Finally, the signal is transmitted via antenna 1117 to a local base station. An automatic gain control (AGC) can be supplied to control the gain of the final stages of the receiver. The signals may be forwarded from there to a remote telephone which may be another cellular telephone, other mobile device or a land-line connected to a Public Switched Telephone Network (PSTN), or other telephony networks.

Voice signals transmitted to the mobile terminal 1101 are received via antenna 1117 and immediately amplified by a low noise amplifier (LNA) 1137. A down-converter 1139 lowers the carrier frequency while the demodulator 1141 strips away the RF leaving only a digital bit stream. The signal then goes through the equalizer 1125 and is processed by the DSP 1105. A Digital to Analog Converter (DAC) 1143 converts the signal and the resulting output is transmitted to the user through the speaker 1145, all under control of a Main Control Unit (MCU) 1103—which can be implemented as a Central Processing Unit (CPU) (not shown).

The MCU 1103 receives various signals including input signals from the keyboard 1147. The keyboard 1147 and/or the MCU 1103 in combination with other user input components (e.g., the microphone 1111) comprise a user interface circuitry for managing user input. The MCU 1103 runs a user interface software to facilitate user control of at least some functions of the mobile terminal 1101 to present search results in an active user interface element. The MCU 1103 also delivers a display command and a switch command to the display 1107 and to the speech output switching controller, respectively. Further, the MCU 1103 exchanges information with the DSP 1105 and can access an optionally incorporated SIM card 1149 and a memory 1151. In addition, the MCU 1103 executes various control functions required of the terminal. The DSP 1105 may, depending upon the implementation, perform any of a variety of conventional digital processing functions on the voice signals. Additionally, DSP 1105 determines the background noise level of the local environment from the signals detected by microphone 1111 and sets the gain of microphone 1111 to a level selected to compensate for the natural tendency of the user of the mobile terminal 1101.

The CODEC 1113 includes the ADC 1123 and DAC 1143. The memory 1151 stores various data including call incoming tone data and is capable of storing other data including music data received via, e.g., the global Internet. The software module could reside in RAM memory, flash memory, registers, or any other form of writable storage medium known in the art. The memory device 1151 may be, but not limited to, a single memory, CD, DVD, ROM, RAM, EEPROM, optical storage, or any other non-volatile storage medium capable of storing digital data.

An optionally incorporated SIM card 1149 carries, for instance, important information, such as the cellular phone number, the carrier supplying service, subscription details, and security information. The SIM card 1149 serves primarily to identify the mobile terminal 1101 on a radio network. The card 1149 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing (1) data and/or (2) information and/or (3) at least one signal, the (1) data and/or (2) information and/or (3) at least one signal based, at least in part, on the following:
at least one determination of an input specifying at least one point in a user interface;
a rendering of a search user interface element at the at least one point; and
at least one determination to generate a search query that includes, at least in part, the at least one point as a search parameter.

2. A method of claim 1, wherein the (1) data and/or (2) information and/or (3) at least one signal are further based, at least in part, on the following:
a rendering of one or more results of the search query in the user interface based, at least in part, on location information associated with the one or more results;
at least one determination of another input for selecting at least one of the one or more results; and
a rendering of another search user interface element at another point in the user interface based, at least in part, on the location information associated with the selected at least one of the one or more results.

3. A method of claim 2, wherein the (1) data and/or (2) information and/or (3) at least one signal are further based, at least in part, on the following:
at least one determination to generate another search query that includes, at least in part, the another point as another search parameter; and
a rendering of one or more other results of the another search query in the user interface based, at in part, on other location information associated with the one or more other results.

4. A method of claim 3, wherein the (1) data and/or (2) information and/or (3) at least one signal are further based, at least in part, on the following:
at least one determination of another input for selecting at least another one of the one or more other results; and
a generation of an itinerary, routing information, or a combination thereof based, at least in part, on the selected at least one result and the selected at least one other result.

5. A method of claim 4, wherein the (1) data and/or (2) information and/or (3) at least one signal are further based, at least in part, on the following:
at least one determination of a hierarchy of the search query, the one or more results, the selected at least one result, the another search query, the one or more other results, the selected at least one other result, or a combination thereof.

6. A method of claim 5, wherein the hierarchy is based, at least in part, on granularity information associated with the search query, the one or more results, the selected at least one result, the another search query, the one or more other results, the selected at least one other result, or a combination thereof.

7. A method of claim 5, wherein the (1) data and/or (2) information and/or (3) at least one signal are further based, at least in part, on the following:
at least one determination of one or more rendering characteristics for the one or more results, the selected at least one result, the one or more other results, the selected at least one other result, or a combination thereof based, at least in part, on the hierarchy; and
a rendering of the one or more results, the selected at least one result, the one or more other results, the selected at least one other result, or a combination thereof in the user interface based, at least in part, on the one or more rendering characteristics.

8. A method of claim 7, wherein the user interface is a three-dimensional user interface, and wherein the one or more rendering characteristics include a z-axis displacement.

9. A method of claim 1, wherein the search query includes, at least in part, a location-based query, an information query, a web query, or a combination thereof and wherein the user interface is for, at least in part, a mapping application, a navigation application, an augmented reality application, a virtual reality application, or a combination thereof.

10. A method of claim 1, wherein the user interface includes, at least in part, a selection of one or more category-based search terms.

11. An apparatus comprising:
at least one processor; and
at least one memory including computer program code for one or more programs,
the at least one memory and the computer program code configured to, with the at least one processor, cause the apparatus to perform at least the following,
determine an input specifying at least one point in a user interface;
cause, at least in part, a rendering of a search user interface element at the at least one point; and
determine to generate a search query that includes, at least in part, the at least one point as a search parameter.

12. An apparatus of claim 11, wherein the apparatus is further caused to:
cause, at least in part, a rendering of one or more results of the search query in the user interface based, at least in part, on location information associated with the one or more results;
determine another input for selecting at least one of the one or more results; and
cause, at least in part, a rendering of another search user interface element at another point in the user interface based, at least in part, on the location information associated with the selected at least one of the one or more results.

13. An apparatus of claim 12, wherein the apparatus is fluffier caused to:
determine to generate another search query that includes, at least in part, the another point as another search parameter; and
cause, at least in part, a rendering of one or more other results of the another search query in the user interface based, at in part, on other location information associated with the one or more other results.

14. An apparatus of claim 13, wherein the apparatus is further caused to:
determine another input for selecting at least another one of the one or more other results; and
cause, at least in part, a generation of an itinerary, routing information, or a combination thereof based, at least in part, on the selected at least one result and the selected at least one other result.

15. An apparatus of claim 14, wherein the apparatus is further caused to:
determine a hierarchy of the search query, the one or more results, the selected at least one result, the another search query, the one or more other results, the selected at least one other result, or a combination thereof.

16. An apparatus of claim 15, wherein the hierarchy is based, at least in part, on granularity information associated with the search query, the one or more results, the selected at least one result, the another search query, the one or more other results, the selected at least one other result, or a combination thereof.

17. An apparatus of claim 15, wherein the apparatus is further caused to:
determine one or more rendering characteristics for the one or more results, the selected at least one result, the one or more other results, the selected at least one other result, or a combination thereof based, at least in part, on the hierarchy; and
cause, at least in part, a rendering of the one or more results, the selected at least one result, the one or more other results, the selected at least one other result, or a combination thereof in the user interface based, at least in part, on the one or more rendering characteristics.

18. An apparatus of claim 17, wherein the user interface is a three-dimensional user interface, and wherein the one or more rendering characteristics include a z-axis displacement.

19. An apparatus of claim 11, wherein the search query includes, at least in part, a location-based query, an information query, a web query, or a combination thereof and wherein the user interface is for, at least in part, a mapping application, a navigation application, an augmented reality application, a virtual reality application, or a combination thereof.

20. An apparatus of claim 11, wherein the user interface includes, at least in part, a selection of one or more category-based search terms.

21.-48. (canceled)
